(19) United States
(12) Patent Application Publication
(10) Pub. No.: US 2010/0309104 A1
(43) Pub. Date: Dec. 9, 2010

(54) PRESENTATION ASSEMBLY AND ASYNCHRONOUS PRESENTATION METHOD THEREOF

(75) Inventors: XIAN-WEI MA, Shenzhen City (CN); YU-HAO TANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/503,866

(22) Filed: Jul. 16, 2009

(30) Foreign Application Priority Data
Jun. 8, 2009 (CN) 200910303046.X

(51) Int. Cl. G09G 3/36; H04B 1/38

(52) U.S. Cl. 345/87; 455/566

(57) ABSTRACT

A presentation assembly for displaying data from a data source includes a liquid crystal display, a projection lens, and a projecting unit. The liquid crystal display includes a panel configured for displaying a graphical user interface, and a frame fitted to the liquid crystal display. The projection lens is mounted to the rear surface of the frame, and extends out of the frame. The projecting unit is installed within the liquid crystal display and includes a storage sub-unit and a signal processing sub-unit. The storage sub-unit is configured for storing a data stream needed to be projected. The signal processing sub-unit is configured for transforming the data stream needed to be projected into a projectable signal input to be projected by the projection lens.

### BACKGROUND

1. Technical Field

The present disclosure relates to a presentation assembly and an asynchronous presentation method thereof.

2. Description of Related Art

When presenting slides, such as POWERPOINT slides, on a screen, a projection system must be used. This projection system typically includes a set of equipments, for example, a host, a display panel, and a projector. In most of these projection systems, only one presentation slide can be displayed on the display panel and the projector at the same time. However, a presenter may not be able to show one slide on the projection screen and view another slide of the same or another presentation on the display panel. This is an inconvenience.

Therefore, what is desired is a presentation assembly and an asynchronous displaying method thereof that can overcome the above described limitations.

### BRIEF DESCRIPTION OF THE DRAWINGS

FIG. 1 is a plane view of a presentation assembly which includes a projecting unit in accordance with an exemplary embodiment.

FIG. 2 is an exploded, isometric view of the presentation assembly of FIG 1.

FIG. 3 is a functional block diagram of the projecting unit of FIG. 1.

FIG. 4 is a flowchart of an asynchronous displaying method, according to another exemplary embodiment.

### DETAILED DESCRIPTION

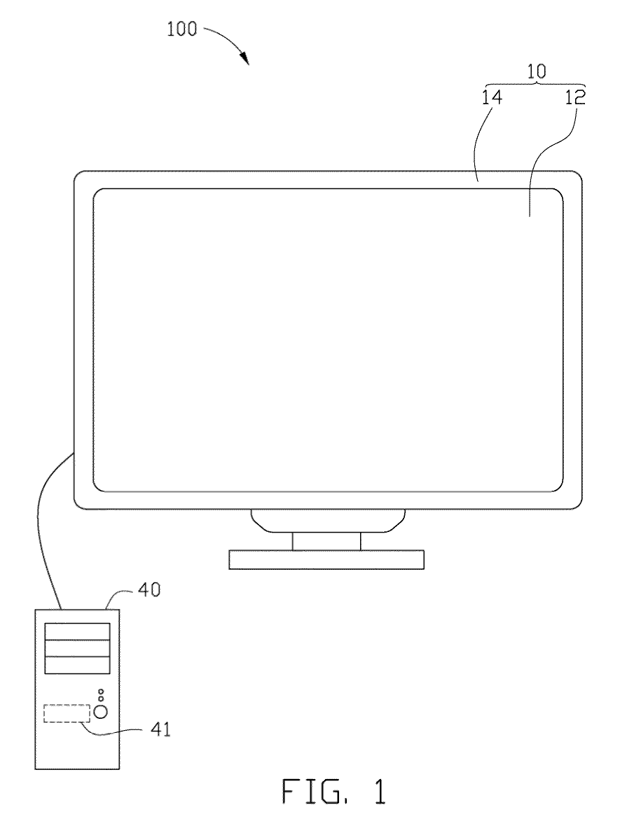

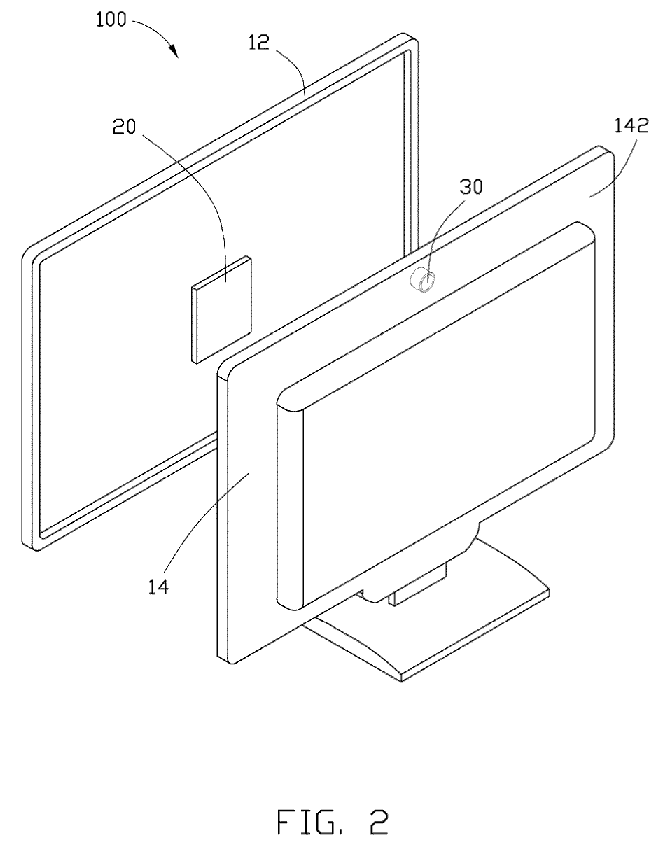

Referring to FIGS. 1-2, a presentation assembly 100 in accordance with an exemplary embodiment is illustrated. In this embodiment, the presentation assembly 100 includes a liquid crystal display (LCD) 10 and a host 40. The LCD 10 is connected to the host 40. The host 40 includes a hard disk 41 which functions as a data source of the presentation assembly 100. It should be mentioned that the presentation assembly 100 is not limited to this embodiment. In other alternative embodiments, the presentation assembly 100 can be a mobile phone.

In detail, the LCD 10 includes a panel 12 and a frame 14. The panel 12 is fitted in the frame 14. In addition to the LCD 10, the presentation assembly 100 further includes a projecting unit 20 and a projection lens 30. The projecting unit 20 is installed within the LCD 10. The projection lens 30 is mounted to a rear surface 142 of the frame 14 generally at the center top of the rear surface 142, and extends out of the frame 14. However, it should be understood that, in other embodiments, the projection lens 30 can also be mounted to other locations of the frame 14.

In this embodiment, the panel 12 is configured for displaying a graphical user interface (GUI) of the host 40. In detail, the panel 12 is an LCD panel.

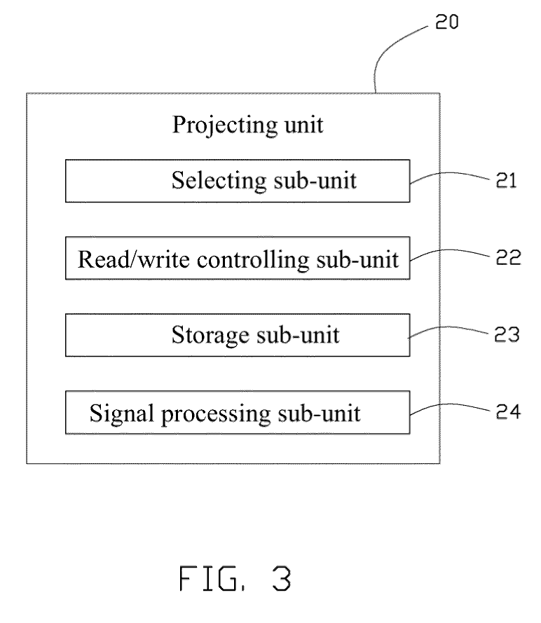

Referring to FIG. 3, the projecting unit 20 includes a selecting sub-unit 21, a read/write controlling sub-unit 22, a storage sub-unit 23, and a signal processing sub-unit 24. The selecting sub-unit 21 is configured for selecting a synchronous display mode or an asynchronous display mode in response to user inputs to the host 40. The synchronous mode is that the panel 12 and the projection lens 30 display data from the same data source, and the asynchronous mode is that the panel 12 and the projection lens 30 display data from different data sources. The data source can be different files on the hard disk or can be one file from the hard disk and another file from a different memory source such as a universal serial bus memory stick or an optical disk. In this embodiment, the panel 12 is a touch panel. Therefore, the selecting sub-unit 21 can select the synchronous display mode or the asynchronous display mode based upon touch inputs on the panel 12. The selecting sub-unit 21 may operate in four modes. The four modes are: a display only mode; a projection only mode; a display and projection mode having the same data source; and a display and projection mode having different data sources. The read/write controlling sub-unit 22 is configured for reading a data stream from the host 40, i.e., the hard disk 41, into the storage sub-unit 23. The storage sub-unit 23 is configured for storing the data stream temporarily. The read/write controlling sub-unit 22 is also configured for writing the data stream stored in the storage sub-unit 23 to the signal processing sub-unit 24. The signal processing sub-unit 24 is configured for transforming the data stream into projectable signals, i.e., video signals. In practice, in addition to the information processing sub-units such as the selecting sub-unit 21, the read/write sub-unit 22, the storage sub-unit 23, and the signal processing sub-unit 24, the projecting unit 20 also includes required optical components such as an optical engine of a conventional projector to optically project the projectable signals on a screen as images.

As compared with current projection system, the projecting assembly 100 integrates the data source, i.e., the host 40, the panel 12, and a projection lens 30 into one equipment. The panel 12 of the LCD 10 and the screen of the projection lens 30 can display asynchronously in this embodiment. In detail, the panel 12 can show the GUI under control of the host 40 while the projection lens 30 can project the data stream under control of the projecting unit 20. However, it should be noted that the panel 12 of the LCD 10 and the projection lens 30 can also display in a synchronous mode if the selecting sub-unit 21 selects the synchronous display mode.

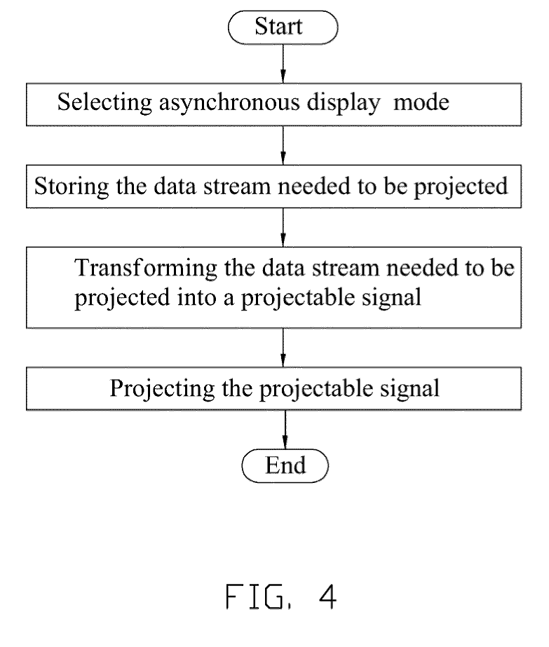

Referring to FIG. 4, a flowchart of an asynchronous displaying method for the presentation assembly 100 is shown. The method includes the following steps: firstly, selecting an asynchronous display mode; secondly, storing the data stream needed to be projected; thirdly, transforming the data stream needed to be projected into a projectable signal; and finally, projecting the projectable signal.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A presentation assembly for displaying data from a data source, the presentation assembly comprising:
a liquid crystal display comprising a panel configured for displaying a graphical user interface, and a frame fitted to the liquid crystal display;
a projection lens mounted to and extending out of the frame; and
a projecting unit installed within the liquid crystal display, the projecting unit comprising:
a storage sub-unit configured for storing a data stream needed to be projected; and
a signal processing sub-unit configured for transforming the data stream needed to be projected into a projectable signal input to be projected by the projection lens.

2. The presentation assembly as claimed in claim 1, wherein the data source is a hard disk of a host, and the liquid crystal display is connected to the host.

3. The presentation assembly as claimed in claim 1, wherein the presentation assembly is a mobile phone.

4. The presentation assembly as claimed in claim 1, wherein the projection lens is mounted to the rear surface of the frame.

5. The presentation assembly as claimed in claim 1, wherein the projecting unit further comprises a read/write controlling sub-unit, and the read/write controlling sub-unit firstly reads a data stream to the storage sub-unit, and then writes the data stream stored in the storage sub-unit to the signal processing sub-unit.

6. The presentation assembly as claimed in claim 1, further comprising a selecting sub-unit, wherein the selecting sub-unit operates in four modes, and the four modes are: a display only mode; a projection only mode; a display and projection mode having the same data source; and a display and projection mode having different data sources.

7. A presentation assembly for displaying data from a data source, the presentation assembly comprising:
a liquid crystal display comprising a panel configured for displaying a graphical user interface, and a frame fitted to the liquid crystal display;
a projection lens mounted to and extending out of the frame; and
a projecting unit installed within the liquid crystal display, the projecting unit comprising:
a selecting sub-unit configured for selecting a synchronous/asynchronous display mode;
a storage sub-unit configured for storing a data stream; and
a signal processing sub-unit configured for transforming the data stream into a projectable signal input to be projected by the projection lens.

8. The presentation assembly as claimed in claim 7, wherein the data source is a hard disk of a host, and the liquid crystal display is connected to the host.

9. The presentation assembly as claimed in claim 7, wherein the presentation assembly is a mobile phone.

10. The presentation assembly as claimed in claim 7, wherein the projection lens is mounted to the rear surface of the frame.

11. The presentation assembly as claimed in claim 7, wherein the projecting unit further comprises a read/write controlling sub-unit, and the read/write controlling sub-unit firstly reads the data stream to the storage sub-unit, and then writes the data stream stored in the storage sub-unit to the signal processing sub-unit.

12. The presentation assembly as claimed in claim 7, wherein the panel is a touch panel.

13. The presentation assembly as claimed in claim 7, wherein the selecting sub-unit operates in four modes, and the four modes are: a display only mode; a projection only mode; a display and projection mode having the same data source; and a display and projection mode having different data sources.

14. An asynchronous displaying method, comprising:
selecting an asynchronous display mode;
storing a data stream needed to be projected;
transforming the data stream into a projectable signal; and
projecting the projectable signal.
